(19) United States
(12) Patent Application Publication
(10) Pub. No.: US 2019/0028599 A1
(43) Pub. Date: Jan. 24, 2019

(54) PRINTING DEVICE WITH WIRELESS-NETWORK MODULE

(71) Applicant: Hewlett-Packard Development Company, L.P., Houston, TX (US)

(72) Inventor: Kevin Lo, Vancouver, WA (US)

(21) Appl. No.: 16/064,214

(22) PCT Filed: Apr. 15, 2016
(86) PCT No.: PCT/US2016/027978

§ 371 Date: Jun. 20, 2018

(51) Int. Cl. H04N 1/00; B41J 29/38

(52) U.S. Cl. CPC H04N 1/00551; B41J 2029/3937; H04N 1/00538; B41J 29/38

(57) ABSTRACT

A printing device having a wireless-network module is disclosed. The printing device includes a housing having a front side including an opening and a repositionable cover over the opening. A main controller is disposed within the housing. A print engine is also disposed within the housing and operably coupled to the main controller. The wireless-network module is operably coupled to the main controller and spaced-apart from the main controller in the housing. The wireless-network module disposed between the print engine and the front side and accessible from the opening.

### BACKGROUND

Printing devices—including printers, copiers, fax machines, multifunction devices including additional scanning, copying, and finishing functions, all-in-one devices, or other devices—produce images on media such as plain paper, photo paper, transparencies, and other media. In some examples, printing devices are sheet fed devices can print on media stacks of metals and polymeric media, such as Compact Discs, in addition to or instead of broad and thin media. Media is positioned as a media stack in an input media tray or on a media roll. Images can be obtained directly from the printing device or communicated to the printing device from a remote location such as from a computing device or computing network. In the example of a sheet fed device, a sheet is selected from the media stack, typically one item at a time, and fed trough a print engine along a feedpath to an output tray.

### BRIEF DESCRIPTION OF THE DRAWINGS

FIG. 1 is a schematic diagram illustrating an example printing device.

FIG. 2 is a schematic diagram illustrating an example of features of the printing device of FIG. 1.

FIG. 3 is a schematic diagram illustrating another example printing device.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Many printing devices include components for connecting to a wireless network. Historically, such components have been mounted to a main printed circuit assembly to increase manufacturing efficiencies and reduce costs. Such configurations tend to promote adequate communications with wireless networks, or wireless connectivity, if the printing device has few metal parts. As higher end printing devices are robust, a metal chassis, sidewalls, and other metal components significantly degrade wireless connectivity. Additionally, the location of the components on or near the main printed circuit assembly made servicing such components difficult. In many examples, main circuit assemblies are located in the rear of the printing device to avoid user accessible features such as ink or toner and media trays, and main feedpath elements such as print engines, scanner carriages, and other elements.

Achieving adequate wireless connectivity has been a challenge. In devices having wireless network components coupled to or near the main circuit assembly, placing the printing device near a wall having metal studs, as is common in many office, school, or laboratory settings, effectively places the wireless network components in a Faraday cage, severely limiting wireless connectivity. Moving the wireless network components away from the rear of the printing device can adversely affect the orientation of antennas, and some devices have demonstrated adequate wireless connectivity for users above and below the floor of the printing device, but poor wireless connectivity for users on the same floor as the printing device. Attempts to extend the antennas to locations away from the rear are often inadequate. For example, longer antenna conductors suffer from signal degradation and signal loss, which also negatively affect wireless connectivity, and solutions to extend antenna conductors away from the rear of the device are expensive and add manufacturing complexity.

Still further, wireless components present manufacturing and servicing issues. Wireless components are often difficult to reach for service technicians, and add to the complexities of and cost of repairs. Further, wireless components mounted on or near circuit assemblies lead to the possibility of damage to electronic components during service and manufacture from electrostatic discharge. Additionally, certain groups of customers of printing devices, such as certain government installations, prohibit wireless connectivity, compounding difficulties in manufacturing or modifications of wireless components.

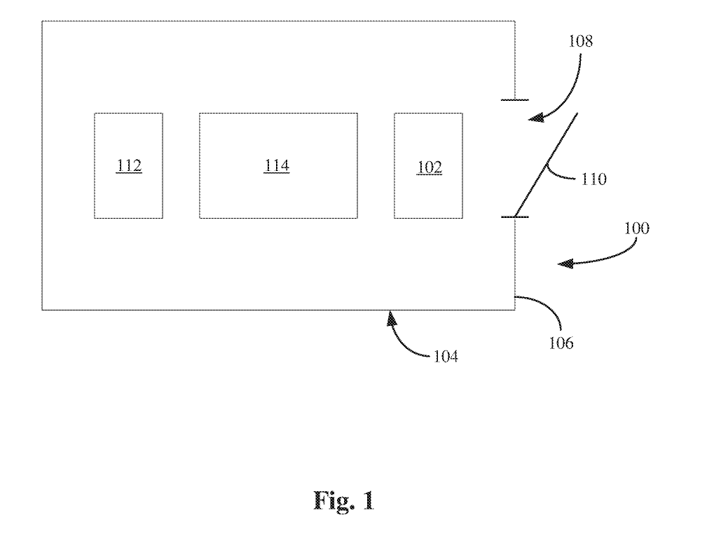

FIG. 1 illustrates an example printing device 100 having a wireless-network module 102 for communicating with a wireless network. The printing device 100 includes a housing 104 having a front side 106 including an opening 108 and a repositionable cover 110 over the opening 108. A main controller 112 is disposed within the housing 104. A print engine 114 is also disposed within the housing 104 and operably coupled to the main controller 112. The wireless-network module 102 is operably coupled to the main controller 112 and spaced-apart from the main controller 112 in the housing 104. The wireless-network module 102 is disposed between the print engine 114 and the front side 106 and accessible from the opening 108.

Exemplars of the printing device 100 can include one or combinations of two or more of a printer, scanner, copier, fax machine, finisher, or other devices. The printing device 100 can be a operated as one or combinations of two or more of a stand alone device, a device coupled to a computer network, or a peripheral or auxiliary device operated by a computer or other processing device. Whether the printing device 100 includes a printer, scanner, copier, fax machine, or combinations of one or more device, the main controller 112 processes an image to be printed on sheet of media. The print engine 114, or print mechanism, translates signals from the main controller 112, receives media from a feed path, and produces the printed image on the media. The print engine 114 can include selected features that affect print speed and output quality or image resolution. Additionally, the print engine 114 can apply a selected type of ink or toner to the media. In one example, the ink or toner can be provided to the print engine in removable or replaceable cartridges, and the cartridges can be accessed via the opening 108 behind the repositionable cover 110.

The repositionable cover 110 is selectively placed over the opening 108 on the front side 106 of the housing 104. In one example, the cover 110 can be detached, i.e., removably attached, from the housing 104 to expose the wireless-network module 102 within the housing 104 via the opening 108. In another example, the cover 110 remains attached to the housing 104, such as via a hinge or other mechanism, and is selectively moved away from the opening 108 to provide access to the wireless-network module 102. In one example, the opening 108 is large enough to allow for the removal the wireless-network module 102. In another example, the opening 108 is large enough to allow a technician to detach the wireless-network module 102 and remove the wireless network module 102 through the opening 108.

In one example, the printing device 100 is conveniently operated so as not to include the front side 106 of the housing 104 facing a wall or floor. In one example, the user can conveniently operate the printing device 100 while facing the front side 106 of the housing 104.

Examples of wireless-networks for use with the printing device 100 include wireless local area network (WLAN) or wireless personal area networks (WPAN) for exchanging computer data over relatively short distances. In one example WLAN includes a wireless distribution method such as spread-spectrum or orthogonal frequency-division multiplexing (OFDM) radio within a limited area such as a home, school, office, or laboratory. Example WLANs include IEEE 802.11, which is a set of media access control (MAC) and physical layer (PHY) specifications for implementing WLAN computer communication in the 900 MHz and 2.4, 3.6, 5, and 60 GHz frequency bands created and maintained by the Institute of Electrical and Electronics Engineers (IEEE) LAN/MAN Standards Committee (IEEE 802). The communication standards and amendments can be implemented in products available under the trade designation Wi-Fi. One example WPAN exchanges data over short distances using short-wavelength ultra-high frequency radio waves in the industrial, scientific, and medical (ISM) band from 2.4 to 2.485 GHz (2402 and 2480 MHz or 2400 and 2483.5 MHz) based on frequency-hopping spread spectrum technology, and can include products available under the trade designation Bluetooth.

The wireless-network module 102 can be configured to include a wireless-network connectivity microcontroller for an embedded application, such as a small computing device on a single integrated circuit including a processor core, memory, and programmable input/output peripherals. Nonvolatile or programmable memory, such as flash memory, ferroelectric random access memory (FeRAM) and one-time programmable read only memory (ROM), to include, for example, computer implemented instructions for controlling the module, is also often included on the chip, as well as a typically small amount of volatile memory such as random access memory (RAM), to include, for example, computer implemented instructions and computer readable data for controlling the module. Other features of the module can include input/output serial ports, such as a universal serial bus (USB) port, universal asynchronous receiver/transmitter (UART) or other serial communication interfaces such as inter-integrated circuits (I²C). The wireless-network module can include one or more network processors subsystems for network-on-a-chip having a dedicated processor and memory for radio, baseband, and media access control (MAC) with encryption features as well as embedded Internet protocol suite (TCP/IP) and cryptographic protocols (TLS/SSL) stacks, hypertext transfer protocol (HTTP) server, and other network protocols. Additionally, the wire-network module 102 can include the wireless-network antenna.

The wireless-network module 102 can be configured to exchange data in the wireless-network with computing device in several configurations. For example, the wireless-network module can be configured to exchange data in the wireless network with the computing device via a networking device intermediary such as a wireless router. The wireless-network module can be configured to exchange data in the wireless network directly with the computing device such as in a peer-to-peer configuration. In some examples, the wireless-network module can be selectively configured to exchange data with a computing device either via a networking device intermediary or peer-to-peer.

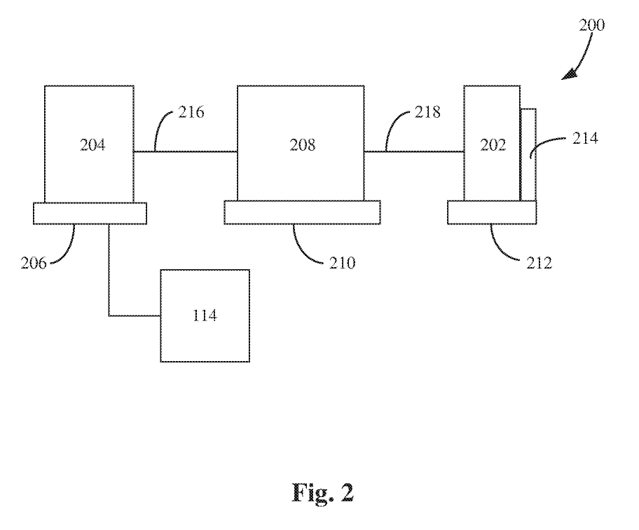

FIG. 2 illustrates an example controller 200, which can be included in the printing device 100 and operated with print engine 114. The controller 200 includes a wireless-network module 202 corresponding with the features of wireless-network module 102 and a main controller 204 having features of controller 112. The main controller 204 is disposed on a main circuit assembly 206 and is operably coupled to control the print engine 114. Controller 200 further includes a dashboard controller 208 disposed on a dashboard circuit assembly 210. The dashboard circuit assembly 210 is spaced-apart from the main circuit assembly 206, and the dashboard controller 208 is directly coupled to communicate with the main controller 204. The wireless-network module 202 is disposed on a wireless-network circuit assembly 212. The wireless-network circuit assembly 212 is spaced-apart from the main circuit assembly 206 and the dashboard circuit assembly 210. In one example, the wireless-network circuit assembly 212 can include an antenna 214 coupled to the wireless-network module 202. The wireless-network module 202 is directly coupled to communicate with the dashboard controller 208.

In one example, the dashboard controller 208 is directly coupled to the main controller 204 via cable 216, which can include one or more of optical or electrical conductors to transmit communications via signals between the dashboard controller 208 and the main controller 204. Cable 216 can include conductors coupled directly to one or both of the controllers 204, 208, one or both of the circuit assemblies 206, 210, or a combination of connections to one or both of controller 204, 208 and circuit assemblies 206, 210. Similarly, the dashboard controller 208 is directly coupled to the wireless-network module 202 via cable 218, which can include one or more of optical or electrical conductors to transmit communications via signals between the dashboard controller 208 and the wireless-network module 202. Cable 218 can include conductors coupled directly to dashboard controllers 208, the wireless-network module 202, one or both of the circuit assemblies 210, 212, or a combination of connections to one or both of wireless-network module 202, dashboard controller 208 and circuit assemblies 210, 212. Further, in one example, the wireless-network module 202 is operably coupled to communicate with main controller 204 via cables 216, 218.

In one example, the circuit assemblies 206, 210, 212 include a printed circuit board to mechanically support and electrically connect other electronic components that make up and support the respective main controller 204, dashboard controller 208, and wireless-network module 202. One or more printed circuit assemblies can be included in the main controller 204 and the dashboard controller 208. In one example, the wireless-network module 202 is disposed on a single printed circuit board, i.e., assembly 212, that can consist of, i.e., include only, the features of providing communications.

In one example of the controller 200, the main controller 204 includes the features of a motherboard, the dashboard controller 208 includes the features of a user input/out device, and the wireless-network module 202 includes wireless-network communication capabilities. The main controller 204 can include a relatively large circuit assembly 206, that may be a foot by a foot and a half in size, and include one or more hard drives in the form of solid state storage, capacitors, inductors, cables, and one or more processors each having multiple logical cores for controlling the features of the sheet fed device 100. The dashboard controller 208 includes electronics and circuitry for operating a touch screen device including a multiple core processor or application specific integrated circuit, solid-state nonvolatile storage, power controls and converters, and other features. In one example, the dashboard controller 208 includes a universal serial bus (USB) hub for connecting cable 218 to the wireless-network module 202 via USB connection and protocol rather than secure digital input output (SDIO).

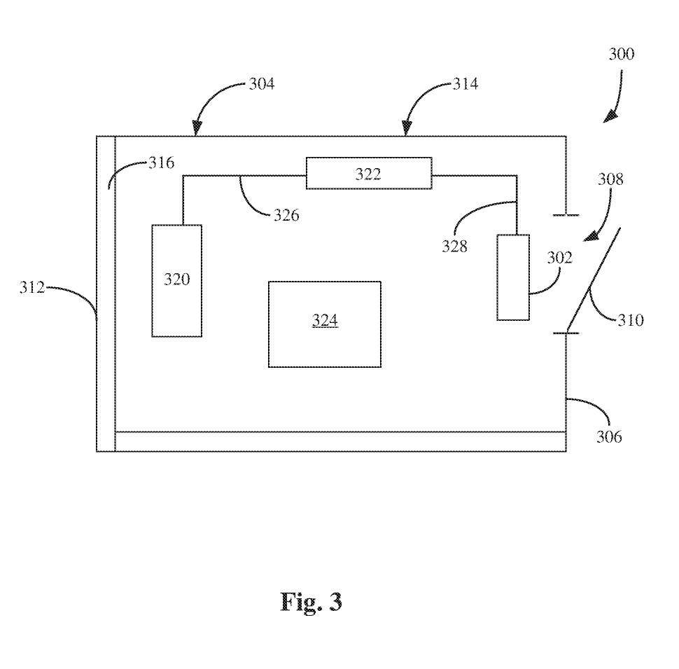

FIG. 3 illustrates an example printing device 300 having a wireless-network module 302 corresponding with wireless-network module 102. Printing device 300 includes a housing 304 having a front side 306 including an opening 308 having a repositionable cover 310 over the opening 308, a back side 312 opposite the front side 306, and a rooftop 314 adjacent to the back side 312 and front side 312. In one example, the printing device can include a chassis 316, such as a chassis 316 formed of metal or other high strength material to support the weight of large objects placed on the rooftop 314. In some examples, the rooftop 314 can include an automatic document feeder, platen, or other devices. In one example, the cover 310 includes front door on the printing device 300 disposed over the opening 308. In another example, the front door allows access to another cover member, such as a hatch, to access the wireless-network module.

The housing 304 can include wireless-network module 302, main controller 320, dashboard controller 322, along with corresponding circuit assemblies, which can correspond to the components in controller 200, and print engine 324 operably couple to the main controller 320. In one example, dashboard controller 322 is operably coupled to the main controller 320 via one or more cables 326 and spaced apart from the main controller 320 in the housing 304. In this example, the main controller 320 is disposed between the print engine 324 and the back side 312, and the dashboard controller 322 is disposed between the print engine 324 and the rooftop 314. A touch screen and other input/output devices, such as USB inputs or SDIO connections are coupled to the housing on the rooftop or near the rooftop, and coupled to the dashboard controller 322 via cables.

The wireless-network module 302 is spaced apart from the main controller 320 and the dashboard controller 322 in the housing 304. In this example, the wireless-network module 302 disposed between the print engine 324 and the front side 306 and is accessible from the opening 308. The wireless-network module 302 is directly coupled to the dashboard controller 322 via a removable cable 328. In one example, the cable 328 is removable from a coupling on the wireless-network module 302. The wireless-network module is operably coupled to the main controller 320 via cable 326. In one example, the wireless network module is removably attached to the chassis 316, such as directly attached to the chassis or directly attached to a plastic member that is attached to the chassis.

The example printing devices 100, 300 and controllers 200 allow for ease in manufacturing during regional integration or other up-stream manufacturing process. For example, the wireless-network modules can be easily installed given regional specification after manufacturing of the other portions of the printing device. Further, the wireless-network modules can be easily removed during regional integration or other upstream manufacturing process for particular configuration for customers not seeking wireless connectivity.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A printing device, comprising:
a housing having a front side including an opening and a repositionable cover over the opening;
a main controller disposed within the housing;
a print engine disposed within the housing and operably coupled to the main controller; and
a wireless-network module operably coupled to the main controller and spaced-apart from the main controller in the housing, the wireless-network module disposed between the print engine and the front side and accessible from the opening.

2. The printing device of claim 1, wherein the housing includes a rooftop above the print engine.

3. The printing device of claim 2 wherein the rooftop includes an automatic document feeder.

4. The printing device of claim 1 comprising a chassis attached to the housing, and the wireless-network module is removably attached to the chassis.

5. The printing device of claim 1 wherein the repositionable cover is removably attached to the housing.

6. The printing device of claim 1 wherein the wireless-network module is disposed on a circuit assembly.

7. The printing device of claim 6 wherein the circuit assembly includes an antenna coupled to the wireless-network module.

8. A controller for a printing device having a print engine, the controller comprising:
a main controller disposed on main circuit assembly, the main controller operably coupled to control the print engine;
a dashboard controller disposed on a dashboard circuit assembly spaced-apart from the main circuit assembly, the dashboard controller directly connected to the main controller; and
a wireless-network module disposed on a wireless-network circuit assembly spaced-apart from the main circuit assembly and the dashboard circuit assembly, the wireless-network module directly connected to the dashboard controller and operably coupled to the main controller.

9. The controller of claim 8 wherein the printing device includes a housing having first side and a second side opposite the first side and wherein the main circuit assembly is disposed between the first side and the print engine and the wireless network module is disposed between the second side and the print engine.

10. The controller of claim 8 wherein the wireless-network circuit assembly includes an antenna coupled to the wireless-network module.

11. The controller of claim 8 wherein the wireless-network circuit assembly is removably attached to the printing device.

12. The controller of claim 11 wherein the wireless-network module is removably attached to the dashboard controller.

13. A printing device, comprising:
a housing having a front side including an opening and a repositionable cover over the opening, a back side opposite the front side, and a rooftop;
a main controller disposed within the housing;
a print engine disposed within the housing and operably coupled to the main controller;
a dashboard controller operably coupled to the main controller and spaced apart from the main controller in the housing, the dashboard controller disposed between the print engine and the rooftop; and
a wireless-network module operably coupled to the main controller and spaced-apart from the main controller and the dashboard controller in the housing, the wireless-network module disposed between the print engine and the front side and accessible from the opening.

14. The printing device of claim 13 wherein the wireless-network module is directly coupled to the dashboard controller.

15. The printing device of claim 13 wherein the wireless-network module is removably coupled to the printing device.
